(19) United States
(12) Patent Application Publication
(10) Pub. No.: US 2018/0130593 A1
(43) Pub. Date: May 10, 2018

(54) COIL COMPONENT

(71) Applicant: Murata Manufacturing Co., Ltd., Kyoto-fu (JP)

(72) Inventors: Takashi SUKEGAWA, Nagaokakyo-shi (JP); Akio IGARASHI, Nagaokakyo-shi (JP)

(73) Assignee: Murata Manufacturing Co., Ltd., Kyoto-fu (JP)

(21) Appl. No.: 15/788,126

(22) Filed: Oct. 19, 2017

(30) Foreign Application Priority Data
Nov. 8, 2016 (JP) 2016-217700

(51) Int. Cl. H01F 27/255; H01F 27/29; H01F 27/28

(52) U.S. Cl. CPC H01F 27/255; H01F 27/2823; H01F 27/29

(57) ABSTRACT

A coil component includes a drum-shaped core including a winding core portion and first and second flange portions that are provided respectively at both end portions of the winding core portion, and a plate-shaped core bridging the first and second flange portions. The first flange portion has a top surface opposed to one principal surface of the plate-shaped core, and a resin containing magnetic powder having a particle size of not less than about 50 nm and not more than about 1000 nm is present between the principal surface of the plate-shaped core and the top surface of the first flange portion.

### CROSS REFERENCE TO RELATED APPLICATIONS

This application claims benefit of priority to Japanese Patent Application 2016-217700 filed Nov. 8, 2016, the entire content of which is incorporated herein by reference.

### TECHNICAL FIELD

The present disclosure relates to a coil component. More particularly, the present disclosure relates to a coil component including a drum-shaped core and a plate-shaped core, the drum-shaped core including a winding core portion around which a wire is wound, and first and second flange portions provided respectively at both end portions of the winding core portion, the plate-shaped core bridging the first and second flange portions.

### BACKGROUND

A technique in relation to the present disclosure is disclosed in Japanese Unexamined Patent Application Publication No. 2015-65272, for example. Japanese Unexamined Patent Application Publication No. 2015-65272 has an object to provide a pulse transformer as a coil component, which can realize a large inductance value even with a small size. In order to achieve the object, it discloses the pulse transformer constituted as follows.

The pulse transformer disclosed in Japanese Unexamined Patent Application Publication No. 2015-65272 includes a drum-shaped core, a plate-shaped core, first and second wires that are wound over a winding core portion of the drum-shaped core to constitute primary windings of the pulse transformer, and third and fourth wires that are wound over the winding core portion to constitute secondary windings of the pulse transformer. Furthermore, in order to achieve the above-mentioned object, an upper surface of a first flange portion of the drum-shaped core, an upper surface of a second flange portion of the drum-shaped core, and regions of a lower surface of the plate-shaped core, the regions opposed respectively to the upper surfaces of the first and second flange portions of the drum-shaped core, are each polished.

Moreover, according to Japanese Unexamined Patent Application Publication No. 2015-65272, an adhesive is applied between respective portions of the first to fourth wires, those portions being wound over the winding core portion, and the plate-shaped core. With such a constitution, grooves used for filling the adhesive are not needed to be additionally formed in the first and second flange portions and the plate-shaped core, and hence the inductance value can be increased correspondingly.

### SUMMARY

However, the technique disclosed in Japanese Unexamined Patent Application Publication No. 2015-65272 has the following problem to be solved.

First, the upper surface of the first flange portion of the drum-shaped core, the upper surface of the second flange portion of the drum-shaped core, and the regions of the lower surface of the plate-shaped core, those regions opposed respectively to the upper surfaces of the first and second flange portions of the drum-shaped core, have to be polished. Because the polishing has to be performed through a plurality of laborious steps, i.e., a series of a polishing step, a washing step, and a drying step, productivity is very low.

Furthermore, because the adhesive serving to fix the plate-shaped core is applied only over the wires, fixation strength of the plate-shaped core with respect to the drum-shaped core is low. In such a situation, if the plate-shaped core is displaced due to external force, heat, etc., there would be a possibility of causing disorder in winding, deformation, and disconnection of the wires. In addition, low positional accuracy of the plate-shaped core with respect to the drum-shaped core may lead to a possibility of causing variations and time-dependent changes in the inductance value.

An object of the present disclosure is to provide a coil component that can be manufactured without requiring laborious steps, and that can suppress reduction of fixation strength of a plate-shaped core with respect to a drum-shaped core.

According to one embodiment of the present disclosure, a coil component includes a drum-shaped core made of a magnetic substance and including a winding core portion and first and second flange portions that are provided respectively at both end portions of the winding core portion, a plate-shaped core made of a magnetic substance and having first and second principal surfaces positioned to face in opposite directions, the plate-shaped core bridging the first and second flange portions, at least one first electrode terminal provided on the first flange portion, at least one second electrode terminal provided on the second flange portion, and at least one wire wound around the winding core portion and connected to the first electrode terminal and the second electrode terminal.

In the coil component, the first flange portion has a top surface opposed to the first principal surface of the plate-shaped core, and a resin containing magnetic powder having a particle size of not less than about 50 nm and not more than about 1000 nm is present between the first principal surface of the plate-shaped core and the top surface of the first flange portion.

The resin containing the magnetic powder dispersed therein functions as an adhesive for bonding the drum-shaped core and the plate-shaped core to each other, while the magnetic powder functions as an aggregate in the adhesive and contributes to reducing magnetic resistance between the flange portion and the plate-shaped core. If the particle size is less than about 50 nm, the magnetic powder would tend to agglomerate, and if the magnetic powder agglomerates, the resin containing the magnetic powder would no longer function as an adhesive. If the particle size is more than about 1000 nm, a gap between the first principal surface of the plate-shaped core and the top surface of the first flange portion would be too large and an effect of reducing the magnetic resistance would be diminished.

In another embodiment of the present disclosure, the resin is present over the entirety of a region in which the top surface of the first flange portion is opposed to the first principal surface of the plate-shaped core. This feature greatly contributes to reducing the magnetic resistance between the flange portion and the drum-shaped core.

In order to enhance the adhesive function of the resin containing the magnetic powder, the particle size of the magnetic powder is preferably not less than about 140 nm, more preferably not less than about 300 nm, and not more than about 400 nm.

An amount of the magnetic powder with respect to a total amount of the resin and the magnetic powder is preferably not less than about 5% by volume from one viewpoint of increasing an effect of the magnetic powder serving as the aggregate, and it is preferably not more than about 40% by volume from another viewpoint of making the magnetic powder harder to agglomerate. More preferably, the amount of the magnetic powder is not less than about 10.9% by volume and not more than about 36% by volume.

In another embodiment of the present disclosure, a gap between the first principal surface of the plate-shaped core and the top surface of the first flange portion is preferably not less than about 2 μm and not more than about 50 μm. When the gap between the first principal surface of the plate-shaped core and the top surface of the first flange portion is not more than about 50 μm, a desired inductance value can be ensured. Furthermore, when the gap is not less than about 2 μm, there is no need of, for example, a pressing step that is to be carried out to forcibly reduce the gap between the first principal surface of the plate-shaped core and the top surface of the first flange portion. In addition, it is possible to increase a degree of freedom in design and a degree of freedom in a working process for the first principal surface of the plate-shaped core and the top surface of the first flange portion, those surfaces defining the above-mentioned gap.

In another embodiment of the present disclosure, when the drum-shaped core and the plate-shaped core are each made of a sintered material such as ferrite, microscopic recesses are present on at least one of the first principal surface of the plate-shaped core and the top surface of the first flange portion. In that case, part of the magnetic powder is preferably penetrated into the recesses together with part of the resin. The penetration of the magnetic powder particles into the recesses can provide an anchoring effect and can increase fixation strength of the plate-shaped core with respect to the drum-shaped core. In addition, the penetration of the magnetic powder into the recesses further reduces the magnetic resistance between the flange portion of the drum-shaped core and the plate-shaped core.

According to the embodiments of the present disclosure, since the magnetic resistance between the flange portion and the plate-shaped core can be reduced with no need of polishing, the coil component is obtained which can be manufactured without requiring a plurality of laborious steps including a polishing step, and which can suppress reduction of fixation strength of the plate-shaped core with respect to the drum-shaped core because the magnetic powder functions as an aggregate.

Other features, elements, characteristics and advantages of the present disclosure will become more apparent from the following detailed description with reference to the attached drawings.

### BRIEF DESCRIPTION OF THE DRAWINGS

FIGS. 1A and 1B illustrate a coil component according to an embodiment of the present disclosure, specifically, FIG. 1A is a front view, and FIG. 1B is a left side view.

FIG. 2 is a microscope photograph representing a joined portion between one flange portion and a plate-shaped core in a trial product of the coil component illustrated in FIGS. 1A and 1B.

FIG. 3 is a front view of a split pin for use in measuring fixation strength of the plate-shaped core with respect to the flange portion.

### DETAILED DESCRIPTION

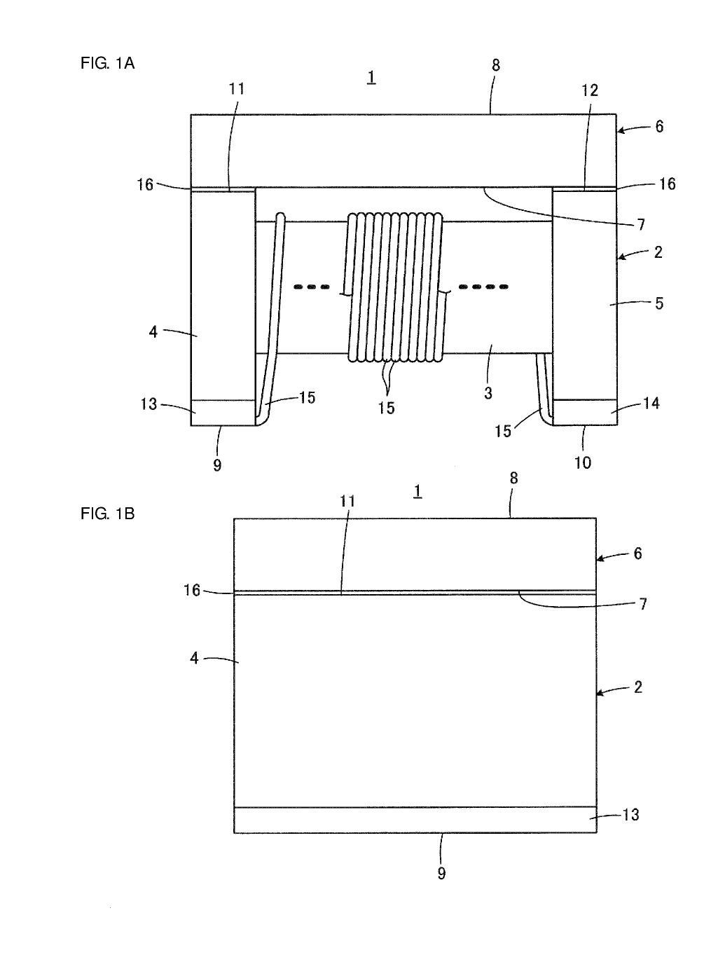

A coil component 1 according to one embodiment of the present disclosure will be described below with reference to FIGS. 1A and 1B.

As illustrated in FIGS. 1A and 1B, the coil component 1 includes a drum-shaped core 2 made of a magnetic substance, such as ferrite. The drum-shaped core 2 includes a winding core portion 3, and first and second flange portions 4 and 5 that are provided respectively at both end portions of the winding core portion 3.

The coil component 1 further includes a plate-shaped core 6 bridging the first and second flange portions 4 and 5. The plate-shaped core 6 has first and second principal surfaces 7 and 8 facing in opposite directions. As in the drum-shaped core 2, the plate-shaped core 6 is also made of a magnetic substance, such as ferrite. Thus, the plate-shaped core 6 constitutes a closed magnetic path in cooperation with the drum-shaped core 2.

The first and second flange portions 4 and 5 have respectively bottom surfaces 9 and 10, which are positioned to face a mounting substrate (not illustrated) when the coil component is mounted, and top surfaces 11 and 12 are positioned on the opposite side to the bottom surfaces 9 and 10. The top surfaces 11 and 12 of the first and second flange portions 4 and 5 are positioned in an opposing relation to the first principal surface 7 of the plate-shaped core 6.

A first terminal electrode 13 is disposed at the bottom surface 9 of the first flange portion 4, and a second terminal electrode 14 is disposed at the bottom surface 10 of the second flange portion 5. The terminal electrodes 13 and 14 are each formed, for example, by applying a conductive paste containing conductive metal powder such as Ag powder, baking the applied conductive paste, and then coating the baked paste with Ni-plating and Sn-plating. As an alternative, the terminal electrodes 13 and 14 may be formed, for example, by bonding conductive metal pieces, which are each made of a copper-based metal such as tough-pitch copper or phosphor bronze, to the flange portions 4 and 5.

A wire 15 is wound over the winding core portion 3. The wire 15 is formed of, for example, a Cu wire with an insulating coating made of resin such as polyurethane, polyester imide, or polyamide imide. One end of the wire 15 is connected to the first terminal electrode 13, and the other end of the wire 15 is connected to the second terminal electrode 14. Thermal pressure bonding, ultrasonic welding, or laser welding, for example, is employed to connect the wire 15 to the terminal electrodes 13 and 14.

A resin 16 containing magnetic powder in a state dispersed therein is present between the first principal surface 7 of the plate-shaped core 6 and each of the top surfaces 11 and 12 of the first and second flange portions 4 and 5. The resin 16 containing the magnetic powder functions as an adhesive, and it is preferably present over the entirety of regions where the top surfaces 11 and 12 of the first and second flange portions 4 and 5 is opposed to the first principal surface 7 of the plate-shaped core 6. It is to be noted that, in FIGS. 1A and 1B, the resin 16 containing the magnetic powder is illustrated in a thickness exaggerated in scale. A preferable thickness of the resin 16 containing the magnetic powder, i.e., preferably a gap between the first principal surface 7 of the plate-shaped core 6 and each of the top surfaces 11 and 12 of the first and second flange portions 4 and 5, will be described later.

A curable resin, a plastic resin, rubber, or an elastomer, for example, can be optionally used as a resin material of the resin 16 containing the magnetic powder. From the viewpoint of heat resistance, however, the resin 16 containing the magnetic powder is preferably a curable resin such as a thermosetting resin or an ultraviolet curable resin. Examples of the curable resin are an epoxy-based resin, a silicone-based resin, a phenol-based resin, and a melamine-based resin. Various types of magnetic metals or magnetic oxides, for example, can be used as the magnetic powder. From the viewpoint of usage environments, however, the magnetic powder is preferably a metal or an oxide, which has a ferromagnetic property at an ordinary temperature. Examples of the magnetic powder are nickel powder, cobalt powder, iron powder, iron-nickel-based ferrite powder, and iron-zinc-based ferrite powder.

A particle size of the magnetic powder is not less than about 50 nm and not more than about 1000 nm. Here, the particle size means D50 called the median size. The particle size can be measured by observing a polished section of the coil component 1 with an SEM (scanning electron microscope). In more detail, the particle size can be determined by observing particles in an SEM photograph that corresponds to an arbitrary region of about 3 μm×3 μm of the resin 16 containing the magnetic powder, and by measuring sizes of the particles in the lengthwise direction with a scale in the SEM photograph taken as an index. The magnetic powder particles in the resin 16 containing the magnetic powder not only function as aggregates, but also contribute to increasing magnetic permeability of the resin 16 containing the magnetic powder. The reason why a lower limit value of the particle size of the magnetic powder is set to about 50 nm as described above resides in that if the particle size is less than about 50 nm, the magnetic powder would tend to agglomerate, and that if the magnetic powder agglomerates, the resin 16 containing the magnetic powder would no longer function as an adhesive. The reason why an upper limit value of the particle size of the magnetic powder is set to about 1000 nm resides in if the particle size is more than about 1000 nm, a gap between the first principal surface 7 of the plate-shaped core 6 and each of the top surfaces 11 and 12 of the first and second flange portions 4 and 5 would be too large and an effect of reducing magnetic resistance would be diminished. The too large gap between the first principal surface 7 of the plate-shaped core 6 and each of the top surfaces 11 and 12 of the first and second flange portions 4 and 5 is attributable to the fact that a minimum value of the gap is dominated by the particle size of the magnetic powder. In other words, as the particle size of the magnetic powder increases, the gap also increases in proportion.

The experimental rule found by the inventors of this application shows that an amount of the magnetic powder with respect to a total amount of the resin and the magnetic powder needs to be about 5% by volume at a minimum from one viewpoint of increasing the effect of the magnetic powder serving as the aggregate, and that the amount is to be not more than about 40% by volume from another viewpoint of making the magnetic powder hard to agglomerate.

The amount of the magnetic powder can be determined by quantitatively measuring metal ingredients of the resin 16 containing the magnetic powder with SEM-EDAX (energy dispersive spectroscopy). When the amount of the magnetic powder cannot be determined with SEM-EDAX, the metal ingredients of the resin 16 containing the magnetic powder may be quantitatively measured with inductively coupled plasma—atomic emission spectroscopy (ICP-AES).

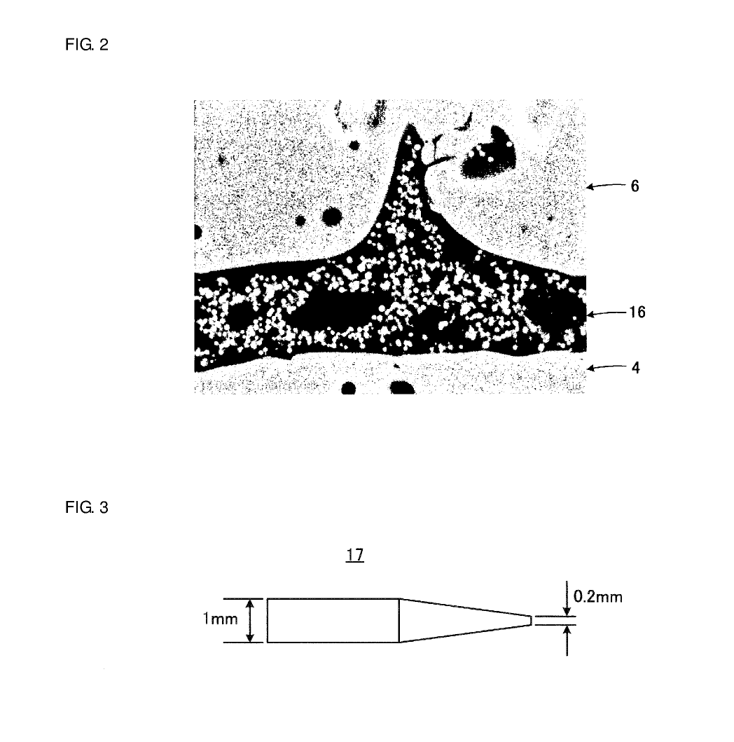

As described above, the drum-shaped core 2 and the plate-shaped core 6 are each made of a sintered material such as ferrite. In that case, microscopic recesses are present on at least one of the first principal surface 7 of the plate-shaped core 6 and the top surfaces 11 and 12 of the first and second flange portions 4 and 5. FIG. 2 is a microscope photograph representing a joined portion between one flange portion 4 and the plate-shaped core 6 in a trial product of the coil component 1. In FIG. 2, the magnetic powder dispersed in the resin 16 containing the magnetic powder appears as a whitish particle.

As illustrated in FIG. 2, part of the magnetic powder is preferably penetrated into the microscopic recesses together with part of the resin. The penetration of the magnetic powder into the recesses can provide an anchoring effect and can increase fixation strength of the plate-shaped core 6 with respect to the drum-shaped core 2. In addition, the penetration of the magnetic powder into the recesses further reduces the magnetic resistance between each of the first and second flange portions 4 and 5 of the drum-shaped core 2 and the plate-shaped core 6.

The following description is made in connection with experimental examples of the coil component 1, which were carried out to determine preferred ranges of the particle size and the amount of the magnetic powder contained in the magnetic powder-containing resin 16 according to an embodiment of the present disclosure.

### Experimental Example 1

The preferred range of the particle size of the magnetic powder was determined in Experimental Example 1.

Nickel powder made by TOHO TITANIUM Co., LTD., having the particle size denoted in each column of “Particle Size of Magnetic Powder” in Table 1 below, was used as the magnetic powder. In a sample No. 4 in Table 1, the magnetic powder was given as a mixture prepared by mixing the nickel powder having the particle size of 140 nm and the nickel powder having the particle size of 400 nm at a weight ratio of 1:2.

In each of samples Nos. 1 to 4, a resin containing magnetic powder was used. The resin containing the magnetic powder was prepared by dispersing the above-mentioned nickel powder(s) into a one-component curable epoxy resin, serving as the above-mentioned resin, to such an extent that an amount of the nickel powder(s) was 32.5% by volume with respect to a total amount of the resin and the nickel powder. In a sample No. 5, only the resin without containing magnetic powder was used.

In Experimental Example 1, the above-mentioned resin containing the magnetic powder or only the resin was used to join the drum-shaped core and the plate-shaped core together. Here, curing conditions of temperature at 160° C. and 7 minutes were employed to cure the resin. Furthermore, in Experimental Example 1, the gap between the top surface of the flange portion of the drum-shaped core and the first principal surface of the plate-shaped core was set to 4 μm.

Regarding the samples Nos. 1 to 5 thus obtained, the “fixation strength” and the “L value” were evaluated as listed in Table 1.

The “fixation strength” was measured as follows. The spacing between the winding core portion and the plate-shaped core was 0.5 mm in a state before winding a wire. On the other hand, a split pin 17 having a shape illustrated in FIG. 3 was prepared. The split pin 17 had a diameter of 0.2 mm at a tip and a diameter of 1 mm in a base portion. The split pin 17 was pushed into the above-mentioned spacing at a speed of 5 mm/min, and a numerical value taken at a time when pushing force was released, i.e., at a time when breakage occurred, was read as the “fixation strength”. It was then checked whether the read value had a sufficient margin in comparison with the lower limit value of strength (17.7 N) specified in AEC-Q200, i.e., the standard specifying reliability of vehicle-loaded components. A numerical value put in a parenthesis in the column of “Fixation Strength” in Table 1 indicates an average value resulting from ten sample products for each of the samples Nos. 1 to 4, and an average value resulting from five sample products for the sample No. 5.

The “L value” represents an inductance value measured under measurement conditions of frequency: 100 kHz, superposition condition: DC 8 mA, and instrument used: impedance analyzer (made by Agilent Technologies, Inc., Model: 4294A). The “L value” denoted in Table 1 indicates an average value resulting from five sample products.

TABLE 1

| Sample | Particle Size of Magnetic | Fixation Force | | L Value |
|---|---|---|---|---|
| No. | Powder [nm] | [N] | | [μH] |
| 1 | 140 | ∘ | (av. 57.5) | 159.6 |
| 2 | 300 | ∘ | (av. 105.8) | 204.2 |
| 3 | 400 | ∘ | (av. 108.2) | 194.4 |
| 4 | 140 + 400 | ∘ | (av. 127.2) | 195.8 |
| 5 | — | ∘ | (av. 82.4) | 182.1 |

As seen from Table 1, the AEC-Q200 standard can be satisfied when the “particle size of magnetic powder” is not less than 140 nm. Thus, it is understood that, when the “particle size of magnetic powder” is not less than 140 nm, the resin containing the magnetic powder is able to sufficiently function as an adhesive.

It is further understood that, when the “particle size of magnetic powder” is set to be not less than 300 nm and not more than 400 nm as represented by the samples Nos. 2 to 4, the “fixation strength” in excess of 82.4 N, i.e., the “fixation strength” of the sample No. 5, which contains no magnetic powder and corresponds to the related art, can be realized.

The “L value” also exhibits a similar tendency to that of the “fixation strength”. More specifically, when the “particle size of magnetic powder” is set to be not less than 300 nm and not more than 400 nm as represented by the samples Nos. 2 to 4, the “L value” in excess of 182.1 μH, i.e., the “L value” of the sample No. 5, which contains no magnetic powder and corresponds to the related art, can be realized.

Though not denoted in Table 1, all the breakages caused in the samples Nos. 1 to 5 with intent to measure the “fixation strength” occurred in a portion of the drum-shaped core or the plate-shaped core, and did not occur in a portion of the resin containing the magnetic powder. This also shows that strong “fixation strength” is obtained in the samples Nos. 1 to 5.

Moreover, a reliability check test was carried out on the samples Nos. 1 to 5. In more detail, a high-temperature preservation test (2000 hours at 150° C. and 2000 hours at 175° C.) a high-temperature and high-moisture preservation test (2000 hours at 85° C. and 85%), and a thermal shock test (2000 cycles of −40° C./+125° C. and 2000 cycles of −55° C./+150° C.) were carried out. As a consequence, in each of the samples Nos. 1 to 5, a good result was obtained and reduction of reliability caused by addition of the magnetic powder was not found.

### Experimental Example 2

The preferred range of the amount of the magnetic powder was determined in Experimental Example 2.

Nickel powder made by TOHO TITANIUM Co., LTD., having the particle size of 300 nm was used as the magnetic powder. The resin containing the magnetic powder was prepared by dispersing the above-mentioned nickel powder into a one-component curable epoxy resin, serving as the above-mentioned resin, with an amount of the nickel powder set to a value denoted in each column of “Amount of Magnetic Powder” in Table 2 below. In a sample No. 10, only the resin without containing magnetic powder was used. The “Amount of Magnetic Powder” represents the amount of the magnetic powder with respect to a total amount of the resin and the magnetic powder in terms of % by volume.

In Experimental Example 2, the above-mentioned resin containing the magnetic powder or only the resin was used to join the drum-shaped core and the plate-shaped core together. Here, resin curing conditions were set as per those set in Experimental Example 1. Furthermore, in Experimental Example 2, the gap between the top surface of the flange portion of the drum-shaped core and the first principal surface of the plate-shaped core was set to 4 μm.

Regarding samples Nos. 6 to 10 thus obtained, the “fixation strength”, the “L value”, and a “breakage mode” were evaluated as listed in Table 2. Measurement conditions of the “fixation strength” and the “L value” were set as per set in Experimental Example 1. The “breakage mode” was evaluated by checking a portion where the breakage caused with intent to measure the “fixation strength” occurred. The occurrence of the breakage in a portion of the drum-shaped core or the plate-shaped core was indicated by “A”, and the occurrence of the breakage in a portion of the resin containing the magnetic powder or the resin was indicated by “B”. In Table 2, a ratio of (number of samples evaluated as A)/(number of samples evaluated as B) was denoted in terms of “A/B” for all ten sample products.

TABLE 2

| Sample | Amount of Magnetic | Fixation | L Value | Breakage Mode |
|---|---|---|---|---|
| No. | Powder [% by volume] | Force [N] | [μH] | A/B |
| 6 | 10.9 | 130.7 | 264.7 | 7/3 |
| 7 | 25.2 | 120.9 | 301.1 | 6/4 |
| 8 | 32.5 | 117.5 | 313.9 | 4/6 |
| 9 | 36.0 | 113.9 | 307.6 | 2/8 |
| 10 | 0 | 103.5 | 242.9 | 1/9 |

As seen from Table 2, when the “amount of magnetic powder” is not less than 10.9% by volume and not more than 36% by volume as represented by the samples Nos. 6 to 9, the “fixation strength” of not less than 113.9 N is obtained, and the “L value” of not less than 264.7 μH is obtained.

Moreover, as seen from comparison among the samples Nos. 6 to 10, as the “amount of magnetic powder” increases, “A/B” increases and a proportion of the breakage occurring in a portion of the drum-shaped core or the plate-shaped core increases.

Because the “particle size of magnetic powder” is 300 nm in all the samples Nos. 6 to 9 listed in Table 2, the sample No. 8 in Table 2 has the “amount of magnetic powder” of 32.5% by volume and the “particle size of magnetic powder” of 300 nm. On the other hand, the “amount of magnetic powder” is 32.5% by volume in all the samples Nos. 1 to 4 listed in Table 1. Accordingly, the sample No. 2 in Table 1 has the “amount of magnetic powder” of 32.5% by volume and the “particle size of magnetic powder” of 300 nm as in the sample 8 in Table 2. Thus, the conditions for the resin containing the magnetic powder are the same between the sample No. 2 in Table 1 and the sample No. 8 in Table 2.

However, comparing the “fixation strength”, the “L value”, and the “breakage mode” between the sample No. 2 in Table 1 and the sample No. 8 in Table 2, different results are obtained between the sample No. 2 and the sample No. 8.

The reason is as follows. First, the difference in the “L value” is attributable to the fact that the configuration of the coil component 1, specifically including respective forms of the drum-shaped core, the plate-shaped core, and winding of the wire over the winding core portion, is changed between Experimental Example 1 and Experimental Example 2.

Next, regarding the “fixation strength”, although the different results are obtained between the sample No. 2 and the sample No. 8, that difference is small and can be regarded as falling within a range of variations. Looking at the above point from the opposite perspective, because reduction of the fixation force of the plate-shaped core with respect to the drum-shaped core is suppressed even when the concrete configuration of the coil component 1 is different as represented by Experimental Examples 1 and 2, it can be said that the present disclosure exhibits the advantageous effect regardless of the concrete configuration of the coil component 1.

### Experimental Example 3

In Experimental Example 3, an L value of a common mode choke coil was examined on condition that the above-mentioned resins containing the magnetic powder and only the resin corresponding to those used in the samples Nos. 6 to 8 and 10 were used, and that the gap between the first principal surface of the plate-shaped core and each of the top surfaces of the first and second flange portions was set to 2 μm and 50 μm. Table 3 lists the examined results.

TABLE 3

| Sample | Gap | |
|---|---|---|
| No. | 2 μm | 50 μm |
| 6 | 232.8 | 146.4 |
| 7 | 258.8 | 164.4 |
| 8 | 260.5 | [symbol] |
| 10 | [symbol] | 129.0 |

(unit: μH)

As seen from Table 3, when the gap is as small as 2 μm, the difference in the amount of the magnetic powder does not so affect the L value. However, when the gap increases to 50 μm, the difference in the amount of the magnetic powder imposes a comparatively great influence on the L value.

Furthermore, comparing numerals of the L values in Table 3, which are surrounded by dotted lines and which correspond to the gap “50 μm” in the case of the sample No. 8 and the gap “2 μm” in the case of the sample No. 10, it is understood that, even when the gap is as large as 50 μm, the L value in excess of that of the sample No. 10 containing no magnetic powder can be obtained, as represented by the sample No. 8, with addition of the magnetic powder.

While, in the above-described Experimental Examples, nickel powder is used as the magnetic powder and a one-component curable epoxy resin is used as the resin, it is confirmed that similar results can be obtained even in the case of employing another type of magnetic powder and another type of resin.

In preferred embodiments of the present disclosure, the coil component may be constituted by a single coil, or a plurality of coils as in a pulse transformer or a common mode choke coil. In other words, the number of wires may be optionally selected, and hence the number of terminal electrodes disposed in each of the flange portions may also be optionally selected.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A coil component comprising:
a drum-shaped core made of a magnetic substance and including a winding core portion and first and second flange portions that are provided respectively at both end portions of the winding core portion;
a plate-shaped core made of a magnetic substance and having first and second principal surfaces positioned to face in opposite directions, the plate-shaped core bridging the first and second flange portions;
at least one first electrode terminal provided on the first flange portion;
at least one second electrode terminal provided on the second flange portion; and
at least one wire wound around the winding core portion and connected to the first electrode terminal and the second electrode terminal,
wherein the first flange portion has a top surface opposed to the first principal surface of the plate-shaped core, and
a resin containing magnetic powder having a particle size of not less than about 50 nm and not more than about 1000 nm is present between the first principal surface of the plate-shaped core and the top surface of the first flange portion.

2. The coil component according to claim 1, wherein the resin is present over an entirety of a region in which the top surface of the first flange portion is opposed to the first principal surface of the plate-shaped core.

3. The coil component according to claim 1, wherein the particle size of the magnetic powder is not less than about 140 nm.

4. The coil component according to claim 3, wherein the particle size of the magnetic powder is not less than about 300 nm and not more than 400 nm.

5. The coil component according to claim 1, wherein an amount of the magnetic powder with respect to a total amount of the resin and the magnetic powder is not less than about 5% by volume and not more than about 40% by volume.

6. The coil component according to claim 5, wherein the amount of the magnetic powder with respect to the total amount of the resin and the magnetic powder is not less than about 10.9% by volume and not more than about 36% by volume.

7. The coil component according to claim 1, wherein a gap between the first principal surface of the plate-shaped core and the top surface of the first flange portion is not less than about 2 μm and not more than about 50 μm.

8. The coil component according to claim 1, wherein microscopic recesses are present on at least one of the first principal surface of the plate-shaped core and the top surface of the first flange portion, and part of the magnetic powder is penetrated into the microscopic recesses together with part of the resin.
